(19) United States
(12) Patent Application Publication
(10) Pub. No.: US 2021/0122098 A1
(43) Pub. Date: Apr. 29, 2021

(54) METHOD FOR PRODUCING A FLAP OF A DEVICE FOR SEALING A FRONT END AND FLAP OF A DEVICE FOR SEALING A FRONT END AIR INTAKE

(71) Applicant: Valeo Systemes Thermiques, Le Mesnil Saint Denis (FR)

(72) Inventor: Jean-Paul Herlem, Le Mesnil Saint Denis (FR)

(73) Assignee: Valeo Systemes Thermiques, Le Mesnil Saint Denis (FR)

(21) Appl. No.: 16/074,139

(22) PCT Filed: Feb. 1, 2017
(86) PCT No.: PCT/FR2017/050221

§ 371 Date: Jul. 31, 2018

(30) Foreign Application Priority Data
Feb. 3, 2016 (FR) 1650845

(51) Int. Cl. B29C 48/11; B29C 48/00; B29C 48/12

(52) U.S. Cl. CPC B29C 48/11; B60K 11/085; B29C 48/12; B29C 48/0022

(57) ABSTRACT

The present invention concerns a method for producing a flap (3) for a sealing device (1) of a motor vehicle, said method comprising the following steps: extruding a hollow profile section formed from an outer skin (310) made from a first material, cutting the hollow profile section to a predefined length (L) so as to form a flap body (31), fitting end pieces (30) at the ends of the flap body (31). The invention also concerns a flap of a device for sealing a front end air intake obtained by such a method.

The present invention relates to sealing devices and more specifically to a method for producing a flap of a sealing device of a front end air intake of a motor vehicle, as well as a flap of a sealing device of a front end air intake obtained by such a method.

The front ends of motor vehicles usually have two main air intakes, referred to as upper and lower air intakes, that are separated by a fender. The heat exchangers of the motor vehicle are usually positioned behind this fender, such as the heat exchanger used for air conditioning the passenger compartment and/or the heat exchanger used to cool the engine.

It is also known to arrange, in the path of the air passing through the main air intakes, usually the low air intake, a support frame comprising a plurality of flaps mounted in a pivoting manner about parallel axes and designed to adopt a plurality of different angular positions ranging from an open position to a closed position, under the action of appropriate control means.

This provides a sealing device belonging to a jalousie that makes it possible to adjust the air flow passing through the air intakes and reaching the heat exchangers. This helps to optimize the efficiency of these heat exchangers as a function of requirements and by varying the quantity of air received by the heat exchangers. Furthermore, at high speeds, the flaps in a closed position help to reduce the drag coefficient of the vehicle, thereby improving the aerodynamics of said vehicle.

The flaps of such sealing devices are usually molded. The method of production by molding the flaps does not enable much production flexibility since the mold has to be changed completely in order to change the types or dimensions of the flaps, which engenders significant costs.

One of the purposes of the present invention is therefore to at least partially overcome the drawbacks in the prior art by proposing an improved production method.

The present invention therefore concerns a method for producing a flap for a sealing device of a motor vehicle, said method comprising the following steps:
extruding a hollow profile section formed from an outer skin made from a first material,
cutting the hollow profile section to a predefined length so as to form a flap body,
fitting end pieces at the ends of the flap body.

The fact that the hollow profile section forming the flap body is made by extrusion helps to achieve outer skins that are thinner than in a production method by molding. As the outer skins are thinner, the flap is lighter. Furthermore, the fact that the hollow profile section forming the flap body is made by extrusion means that said production method is cheaper and more flexible than molding. Indeed, there is no need to change a mold to change the length of the flaps, one need simply change the cutting length of the hollow profile section. To change the structure of the flap body, either in terms of shape or width, one need simply change the die of the extruder, which is considerably less costly than a whole mold.

According to one aspect of the invention, during the extrusion step of the hollow profile section, at least one strut is formed in the hollow of said profile section.

According to another aspect of the invention, the production method includes an additional step in which a seal is positioned on at least one of the edges of the flap body.

According to another aspect of the invention, the extrusion step is a coextrusion between the first material intended to form the hollow profile section and a second material intended to form a seal on at least one of the edges of the hollow profile section.

According to another aspect of the invention, the hollow profile section has a cross section with a substantially oval profile.

According to another aspect of the invention, the first material is a metal material.

According to another aspect of the invention, the thickness of the outer skin of the flap body is between 0.1 and 0.5 mm, preferably between 0.2 and 0.3 mm.

According to another aspect of the invention, the first material is a thermoplastic polymer.

According to another aspect of the invention, the thickness of the outer skin of the flap body is between 0.5 and 1 mm, preferably between 0.7 and 0.9 mm.

The invention also concerns a flap of a device for sealing a front end air intake obtained by such a method. The flap according to the invention includes a body with an outer skin, the outer skin comprising a hollow profile section, and two end pieces arranged at the ends of the flap body, each end piece being arranged to stopper one corresponding hollow profile section only. In other words, each end of the flap has one end piece only, and consequently each end piece only covers or stoppers or blocks one end of the flap, the flap having a hollow section or profile.

Such a flap is therefore lighter than the flaps in the prior art, while providing satisfactory mechanical strength.

According to one aspect of the invention, the end pieces have different shapes.

According to another aspect of the invention, the flap body has at least one strut linking two opposing portions of the outer skin.

According to another aspect of the invention, at least one end piece has a pin extending along the pivot axis that is designed to cooperate with a bearing carried by a support frame.

Other features and advantages of the invention will become more clearly apparent on reading the description below, given by way of non-limiting examples and the attached drawings, in which:

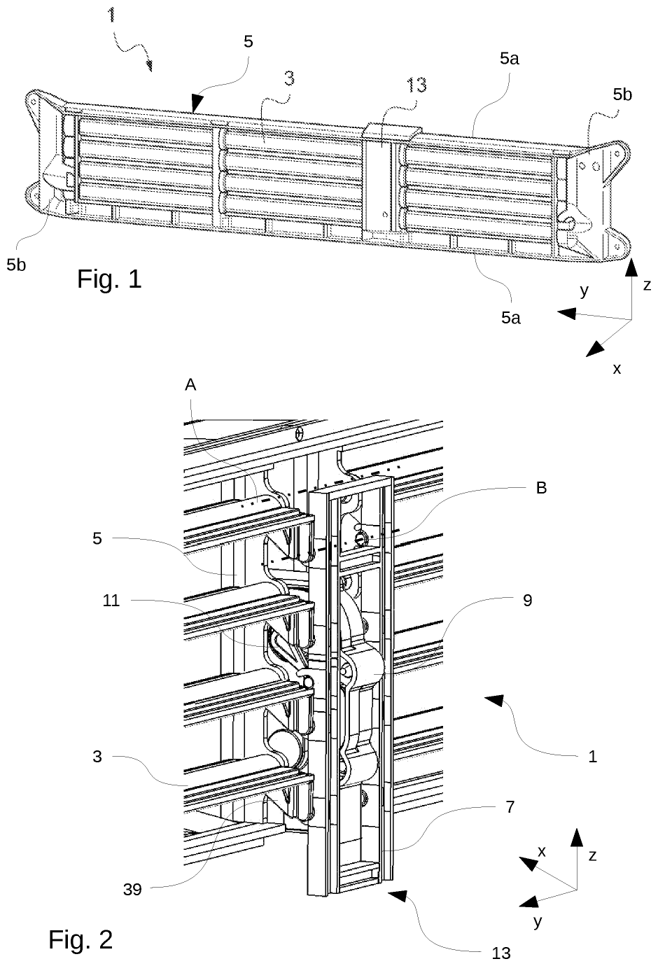

FIG. 1 is a schematic perspective front view of a sealing device in a closed position.

FIG. 2 is a schematic perspective view of a control element,

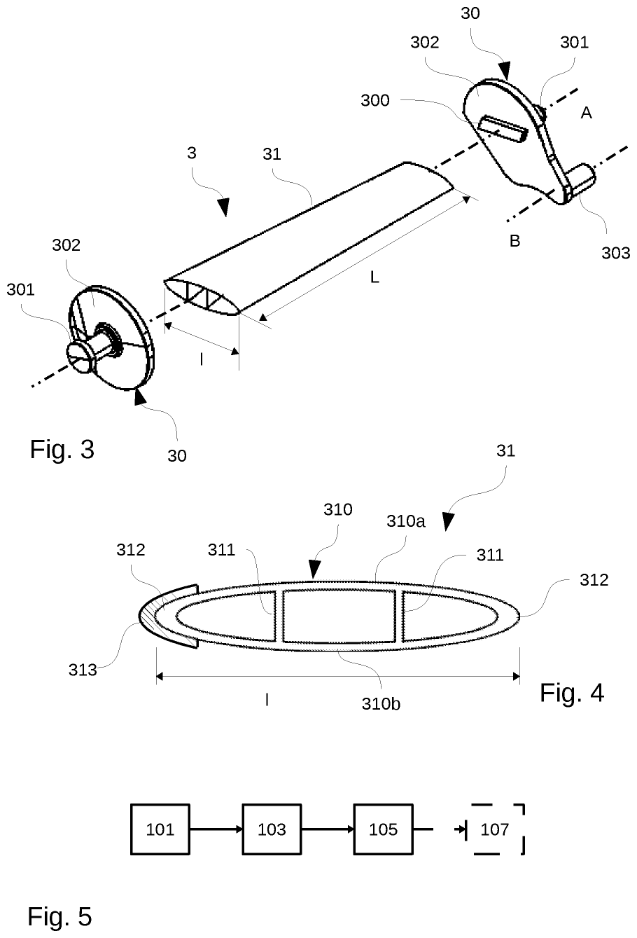

FIG. 3 is an exploded schematic perspective view of a flap,

FIG. 4 is a schematic view of a cross section of a flap body,

FIG. 5 is a flow diagram of the steps of the method for producing a flap.

Identical elements in different figures are identified using the same reference signs.

The following embodiments are examples. Although the description refers to one or more embodiments, this does not necessarily mean that each reference sign refers to the same embodiment, or that the features apply only to one embodiment. Individual features of different embodiments may also be combined or swapped to provide other embodiments.

In the present description, certain elements or parameters may be numbered, for example first element or second element, or first parameter and second parameter, or first criterion and second criterion, etc. In this case, such numbering is merely intended to differentiate and describe elements, parameters or criteria that are similar but not identical. This numbering does not imply priority of one element, parameter or criterion over another, and as such descriptions can be simply interchanged without thereby moving outside the scope of the present description. Furthermore, this numbering does not imply any chronological order, for example when assessing criteria.

An axis system XYZ is used in FIGS. 1 and 2 to show the viewing angle of each of said figures in relation to one another. The axes of this system can also relate to the different orientations of the motor vehicle. The axis X can be the axis along the length of the vehicle, the axis Y can be the axis across the width of the vehicle and the axis Z can be the axis along the height of the vehicle.

FIG. 1 is a schematic perspective view of a sealing device in a closed position. More precisely, FIG. 1 shows the outer face of said sealing device 1, i.e. the face oriented towards the outside of the motor vehicle.

Said sealing device 1 has a support frame 5 including notably two longitudinal cross members 5a extending parallel to the axis Y of the axis system, and at least two side pillars 5b extending parallel to the axis Z of the axis system and linking said longitudinal cross members 5a. Advantageously, the support frame 5 is made of plastic and the two longitudinal cross members 5a and the at least two side pillars 5b are obtained by injection molding. The support frame 5 can be molded as a single part in order to improve the rigidity thereof.

The flap or flaps 3 are installed inside said support frame 5. If there is a plurality of flaps 3, same are arranged in rows of flaps 3 parallel to one another and form a set of flaps 3. A control element 13 is positioned at one of the ends of the flap 3 or set of flaps 3 to enable the rotation of the flap or flaps 3 about a pivot axis A between an open position (not shown) in which the flap or flaps 3 are arranged such that an air flow can pass through the sealing device 1, notably into the support frame 5, and a closed position shown in FIG. 1, in which the flap or flaps 3 are arranged such that an air flow cannot pass through the sealing device 1.

As shown in FIG. 1, a sealing device 1 of a front end air intake of a motor vehicle may have several sets of flaps 3 extending across the entire width of the support frame 5. The sets of flaps 3 can be separated by the control element 13 to ensure the synchronous rotation thereof.

As shown in FIG. 2, the control element 13 is notably a connecting rod 7. The flap or flaps 3 include a control arm 39 that is perpendicular to the pivot axis A thereof and bears a link pin 303 (shown in FIG. 3) along a link axis B. The link pin 303 enables the flap 3 and the connecting rod 7 to be linked together. The pivot axis A and the link axes B are not the same, but both are parallel to the axis Y of the axis system. Said control arm 39 is usually made from the material of said flaps 3.

The control element 13 usually includes an actuator 9. The actuator 9 can be electric, for example an electric motor, or pneumatic, for example a pneumatic jack. Said actuator 9 applies a translational movement to the connecting rod 7 along the axis Z of the axis system, by pivoting a lever 11.

Each flap 3 can pivot about a pivot axis A defined by the link between said flap and the support frame 5. The link pins 303 between the flaps 3 and the control connecting rod 7 are eccentric in relation to the pivot axes A such that a translational movement parallel to the axis Z of the axis system of the control connecting rod 7, under the action of the actuator 9, pivots the flaps 3 about the respective pivot axes A thereof, thereby causing said flaps 3 to move from one position to another.

Since all of the flaps 3 are linked to the same connecting rod 7, all of said flaps 3 move from an open position to a closed position synchronously. The set may also comprise just one flap 3.

The flap according to the invention includes a flap body 31 with an outer skin 310, said outer skin 310 comprising a hollow profile section, and one end piece 30 arranged at each end of the flap body 31, each end piece 30 being arranged to stopper one corresponding hollow profile section only.

As shown in FIG. 3, a flap 3 may have an elongate flap body 31 of length L extending along the pivot axis A thereof. The flap body 31 can notably have a cross section of width 1. The cross section of the flap body 31 can more specifically have a substantially oval profile. Other shapes for the profile of the cross section of the flap body 31 are nonetheless entirely possible, for example rectangular or with a hollow central portion from which fins extend.

End pieces 30 are arranged at each end of the flap body 31. In the present case, the ends are understood to relate to the longitudinal direction of the flap body 31. The end pieces 30 have projections 300 on a first face oriented towards the flap body 31, said projections 300 projecting parallel to the pivot axis A to fit into the ends of the flap body 31. Said end pieces 30 also have a pin 301 on a second face opposite the first face, said pin 301 extending along the pivot axis A of the flap 3 and cooperating with a bearing carried by the support frame 5. The end pieces 30 can also have a flange 302 at the interface between the end pieces 30 and the ends of the flap body 31, said flange 302 extending perpendicular to the pivot axis A. Said flanges 302 notably help to protect the support frame 5 and the control element 13 from any water and dust that could reach the flap body 31.

At least one of the end pieces 30 also has the link pin 303 on the second face thereof, said link pin 303 extending along the link axis B such as to form the control arm 39 and to link the flap 3 to the connecting rod 7.

The end pieces 30 are preferably made of plastic by injection molding. Said end pieces 30 are arranged on both ends of the flap body 31 and can be shaped differently, as shown in FIG. 3, or be the same shape, which helps to reduce production costs.

FIG. 4 shows a cross section of a flap body 31. The flap body 31 has an outer skin 310 delimiting a hollow. The outer skin 310 is made by extruding the first material. This first material can for example be a metal material and enable the thickness of said outer skin 310 to be between 0.1 and 0.5 mm, preferably between 0.2 and 0.3 mm. The first material can also be a thermoplastic polymer and enable the thickness of said outer skin 310 to be between 0.5 and 1 mm, preferably between 0.7 and 0.9 mm. These thicknesses of the outer skin 310 are less than the thicknesses of the flaps 3 made by molding.

Inside the hollow thereof, the flap body 31 can also have at least one strut 311 linking two opposing portions 310a and 310b of the outer skin 310 of the cross section. These struts 311 enable the flap body 31 to remain rigid regardless of the length L thereof, while staying light. The number of these struts 311 depends on the width 1 of the flap body 31. The greater the width 1, the more struts 311 there are. The struts 311 are formed at the same time and from the same material as the outer skin 310, by extrusion.

The flap body 31 can also have a seal 313 on at least one of the edges 312 thereof, said seal 313 being made of a second material, notably an elastic material. The edges 312 are the ends of the cross section of the flap body 31. Said edges 312 extend parallel to the pivot axis A. This second material can be a thermoplastic elastomer (TPE), for example a thermoplastic styrenic elastomer (TPS) such as polystyrene-b-poly(ethylene/butylene)b-polystyrene (SEBS). This seal 313 seals the flaps 3 in relation to one another and with the support frame 5 when said flaps are in the closed position. The seal 313 can be glued to the edge of the flap body 31 or made by simultaneous extrusion with the outer skin 310 and the strut or struts 311, in which case the process is coextrusion.

The flap according to the invention includes a body with an outer skin, the outer skin comprising a hollow profile section, and two end pieces arranged at the ends of the flap body, each end piece being arranged to stopper one corresponding hollow profile section only.

According to one aspect of the invention, the end pieces have different shapes.

According to another aspect of the invention, the flap body has at least one strut linking two opposing portions of the outer skin.

According to another aspect of the invention, at least one end piece has a pin extending along the pivot axis that is designed to cooperate with a bearing carried by a support frame.

FIG. 5 is a diagram showing the steps of the method for producing a flap 3. Said production method includes the following steps:
a first step 101 in which a hollow profile section is extruded from a first material, said hollow profile section having a cross section. During this first step 101, at least one strut 311 can be formed in the hollow of said profile section,
a second step 103 in which the hollow profile section is cut to a predefined length L so as to form a flap body 31,
and a third step 105 in which end pieces 30 are fitted at the ends of the flap body 31.

According to a first embodiment, said production method can include an additional step 107 in which a seal 313 is positioned on at least one of the edges 312 of the flap body 31. Said additional step 107 is carried out after the first extrusion step 101, for example just after this latter, or after the second step 103, or after the third step 105. The seal 313 can for example be glued to the edge 312 of the flap body 31.

According to a second embodiment, the first extrusion step 101 is a coextrusion between the first material intended to form the hollow profile section and the second material intended to form the seal 313 on at least one of the edges 312 of the hollow profile section.

The fact that the hollow profile section forming the flap body 31 is made by extrusion helps to achieve outer skins 311 that are thinner than in a production method by molding. The thinner outer skins 310 mean that the flaps 3 are lighter, but retain rigidity, notably on account of the presence of the struts 311, but also the substantially oval shape thereof.

Using a thermoplastic polymer as the first material, it is possible to make the outer skins 310 with a thickness of between 0.5 and 1 mm, notably between 0.7 and 0.9 mm.

The first extrusion step 101 also allows the outer skins 310 to be made of a first metal material. If said first material is metal, it is possible to make the outer skins 310 with a thickness of between 0.1 and 0.5 mm, notably between 0.2 and 0.3 mm.

Furthermore, since the first step 101 is an extrusion step, said production method is cheaper and more flexible than molding. Indeed, there is no need to change a mold to change the length of the flaps 3, one need simply change the cutting length of the hollow profile section. To change the structure of the flap body 31, either in terms of shape, width 1 or number of struts 311, one need simply change the die of the extruder, which is considerably less costly than a whole mold.

Thus, the production method according to the invention clearly enables the production of lighter and more rigid flaps 3, said production method being cheap and flexible.

1. A method for producing a flap for a sealing device of a motor vehicle, said method comprising:
extruding a hollow profile section formed from an outer skin (310) made from a first material;
cutting the hollow profile section to a predefined length so as to form a flap body; and
fitting end pieces at the ends of the flap body.

2. The production method as claimed in claim 1, wherein during the extrusion step of the hollow profile section, at least one strut (311) is formed in the hollow of said profile section.

3. The production method as claimed in claim 1, further comprising positioning a seal on at least one of the edges of the flap body.

4. The production method as claimed in claim 1, wherein the extrusion step is a coextrusion between the first material intended to form the hollow profile section and a second material intended to form a seal on at least one of the edges of the hollow profile section.

5. The production method as claimed in claim 1, wherein the hollow profile section has a cross section with a substantially oval profile.

6. The production method as claimed in claim 1, wherein the first material is a metal material.

7. The production method as claimed in claim 6, wherein the thickness of the outer skin of the flap body is between 0.2 and 0.3 mm.

8. The production method as claimed in claim 1, wherein the first material is a thermoplastic polymer.

9. The production method as claimed in claim 8, wherein the thickness of the outer skin of the flap body is between 0.7 and 0.9 mm.

10. A flap of a sealing device of an air intake comprising:
a flap body with an outer skin,
said outer skin comprising a hollow profile section; and
one end piece arranged at each end of the flap body, each end piece being arranged to stopper one corresponding hollow profile section only.

11. The sealing device flap as claimed in claim 10, in which the end pieces arranged at the two ends of the flap body are of different shapes.

12. The sealing device flap as claimed in claim 10, in which the flap body has at least one strut linking two opposing portions of the outer skin.

13. The sealing device flap as claimed in claim 10, in which at least one end piece has a pin extending along the pivot axis of the flap that is designed to cooperate with a bearing carried by a support frame.
